(19) United States
(12) Patent Application Publication
(10) Pub. No.: US 2008/0105497 A1
(43) Pub. Date: May 8, 2008

(54) AccessTower

(75) Inventors: Michael Ashley, Merseyside (GB); Anthony Charles Lawrence Pugh, Liverpool (GB)

Correspondence Address: BROOKS KUSHMAN P.C., 1000 TOWN CENTER, TWENTY-SECOND FLOOR, SOUTHFIELD, MI, 48075, US

(73) Assignee: WOLFE DESIGNS LIMITED, Lancashire (GB)

(21) Appl. No.: 10/597,063

(22) PCT Filed: Jan. 7, 2005
(86) PCT No.: PCT/GB05/00025

§ 371 Date: Sep. 13, 2007

(30) Foreign Application Priority Data
Jan. 10, 2004 (GB) 0400433.9
Aug. 6, 2004 (GB) 0417563.4

(51) Int. Cl. B66F 11/04; B66C 23/78

(52) U.S. Cl. 187/269; 187/250

(57) ABSTRACT

An access tower comprises a movable wheeled base (10) to which is mounted one end of a scissor lift mechanism (12), the other end of which supports a working platform (14). The scissor lift (12) can be actuated to displace the working platform (14) between a fully retracted or stowed condition and a fully extended or deployed condition.

The present invention relates to access towers and in particular to access towers which can be extended into an operative condition and retracted into a stowed condition.

Access towers are used when it is necessary for work to be carried out for a substantial period of time at a height which is normally inaccessible. One form of access tower is in the form of interconnecting sections of scaffolding which, when assembled, support a working platform from which work may be carried out. Another form of access tower is in the form of a working platform located at the upper end of a “lazy tongs” or scissor lift type framework and which is extensible and retractable by means of hydraulic rams extending between different sections of the scissor lift framework.

The problem with the first type of access tower is that it requires skilled personnel to assemble it, since it is normally classified as being scaffolding. Moreover, the assembled tower is usable at one height only and must be partially dismantled or added to if the working platform is required at a different height.

The second type of access tower suffers from the requirement for a hydraulic pressure source for operation, which increases the cost and requires training before it can be safely used.

It is an object of the present invention to provide an access tower which can be quickly and easily erected at the desired height without the necessity for external power.

In accordance with a first aspect of the present invention, an access tower comprises a base, a scissor lift means having a lower end mounted on the base, a working platform mounted at the upper end of the scissor lift means and means for applying a force to the lower end of the scissor lift means to urge the scissor lift means into an extended condition.

Preferably, the means for applying a force comprises biasing means acting on the lower end of the scissor lift means which urge the scissor lift means into an extended condition.

By urging the scissor lift means into an extended condition, it is possible for the access tower to be erected and retracted manually, without the need for an external power source such as hydraulic pressure.

Preferably, the biassing means acts only on the lower end of the scissor lift means. This ensures that the forces supporting the working platform and the weight of the scissor lift means itself are transmitted evenly through the whole of the scissor lift means, in contrast to the prior art hydraulically actuated access towers, resulting in easier construction and improved reliability

Preferably, the biassing means comprises spring means. The spring means may comprise tension spring means and/or compression spring means.

In one embodiment the spring means acts on a mounting which is movably, e.g. slidably, mounted on the base. The mounting may comprise a block which is slidably disposed with respect to the base. In one arrangement, the block is slidably disposed in a hollow frame member forming part of the base.

Preferably, the biassing means applies a force which compensates for at least 75% of the effort required to raise the access lower to an erected condition, more preferably 85% or 90% of the effort. Ideally, the biassing means applies a force which compensates for substantially 100% of the effort required to raise the access tower to an erected condition.

Instead of, or in addition to, the biassing means there may be other means for applying force to the lower end of the scissor lift means to urge the scissors lift means into an extended condition. Preferably, such other means are manually powered.

In one embodiment, the access tower further comprises support means for providing structural support to the scissor lift means in the extended condition.

The support means may comprise at least one telescopically extendible leg, extendible between a stowed condition and at least one predetermined extended condition. Preferably, the extendible leg has a plurality of predetermined extended configurations so as to accommodate varying heights of the working platform relative to the base. More preferably, the support means comprises a pair of telescopically extendible legs.

Preferably the support means is mountable on the access tower. More preferably the support means is pivotally mounted on the access tower.

In accordance with a second aspect of the present invention, an access tower comprises a base, scissor lift means having a lower end mounted on the base and a working platform mounted at the upper end of the scissor lift means, the scissor lift means comprising two spaced-apart lazy tongs assemblies and further comprising a plurality of laterally extending bars extending between the two lazy tongs assemblies.

The provision of the laterally extending bars between the two lazy tongs assemblies effectively forms rings of a ladder to allow access to be gained to the working platform.

The laterally extending bars may extend between load-supporting members on each of the two lazy tongs assemblies, for example, between pivot points on each of the two lazy tongs assemblies. The laterally extending bars may form a pivot for each of the two lazy tongs assemblies.

Alternatively, or in addition, the scissor lift means may comprise a laterally-extending bar mounted on a linkage connected to one or both of the lazy tongs assemblies which causes the bar to rise and fall with the scissor lift means.

The linkage may comprise two parallelogram linkages located one on each of the lazy tongs assemblies.

By way of example only, a specific embodiment of the present invention will now be described with reference to the accompanying drawings, in which:

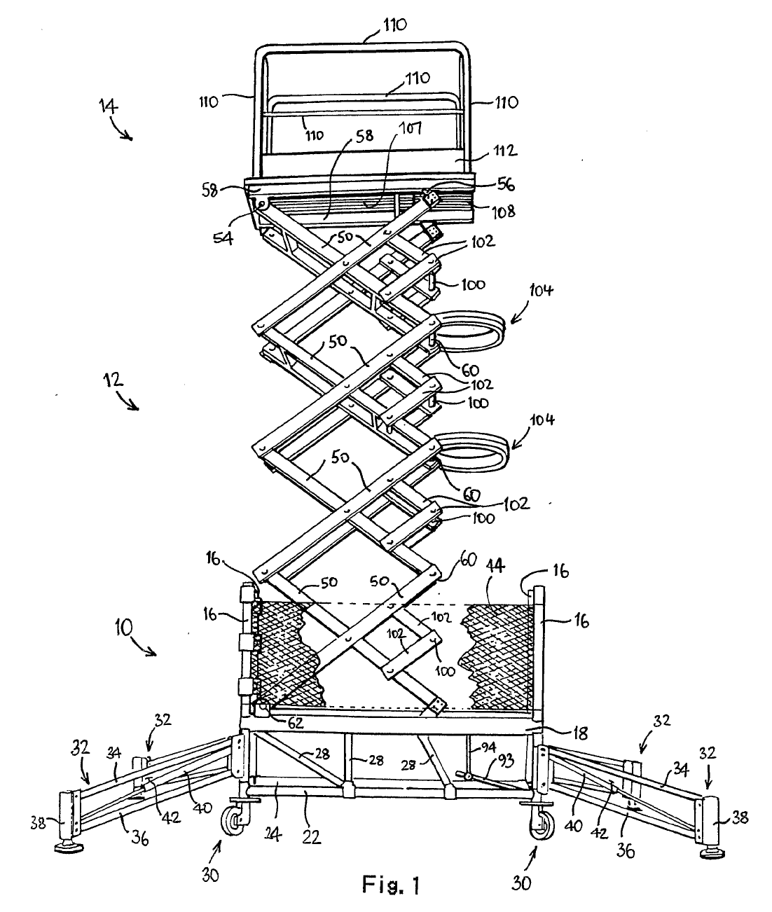

FIG. 1 is a perspective view of an embodiment of access tower in accordance with the present invention, shown in a fully extended or deployed condition;

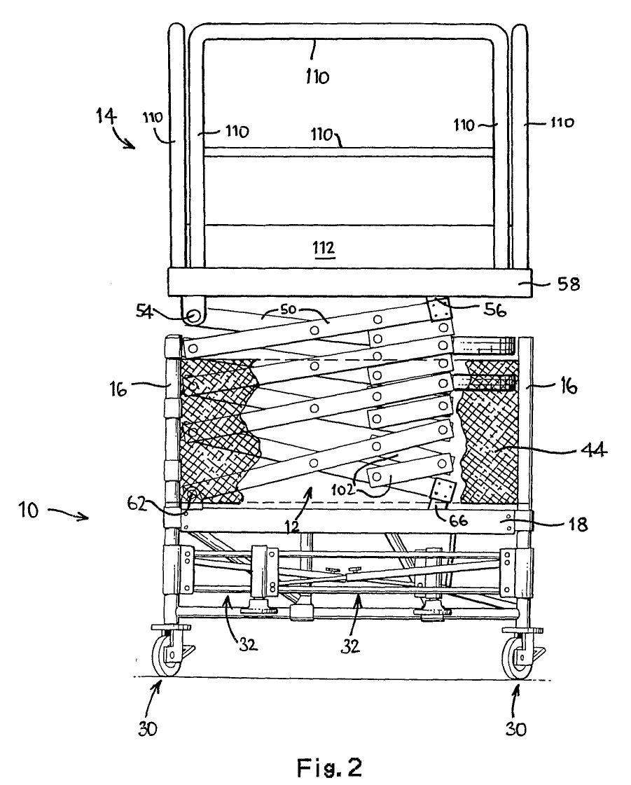

FIG. 2 is a perspective view of the access tower of FIG. 1, shown in a fully retracted or stowed condition;

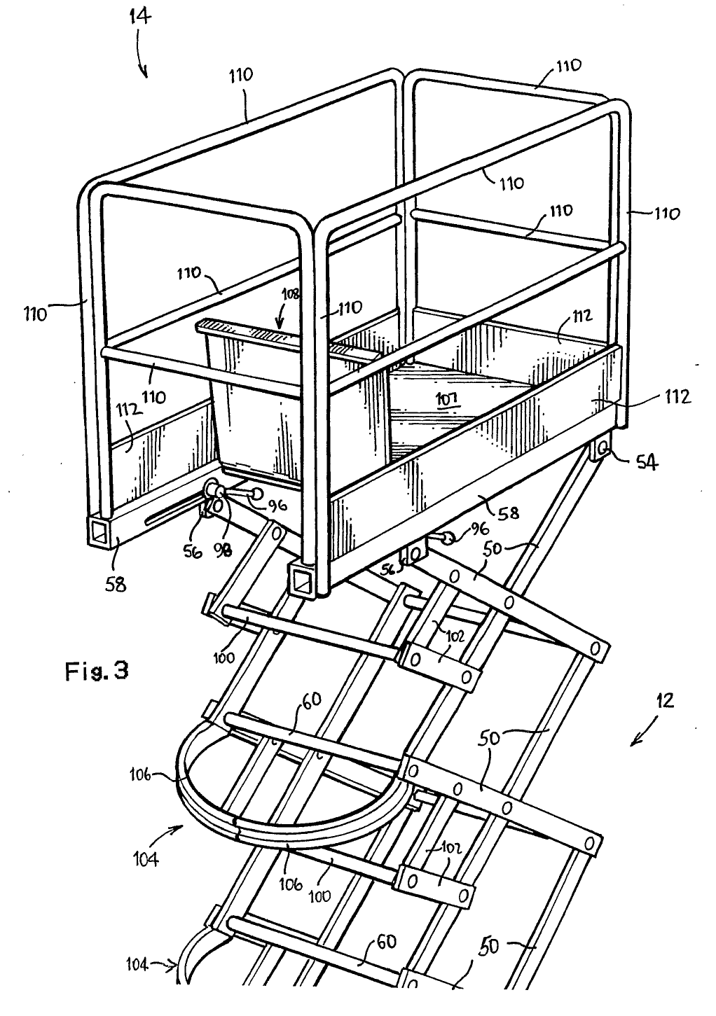

FIG. 3 is an enlarged perspective view of the upper portion of the access tower of FIG. 1, shown in the fully extended condition;

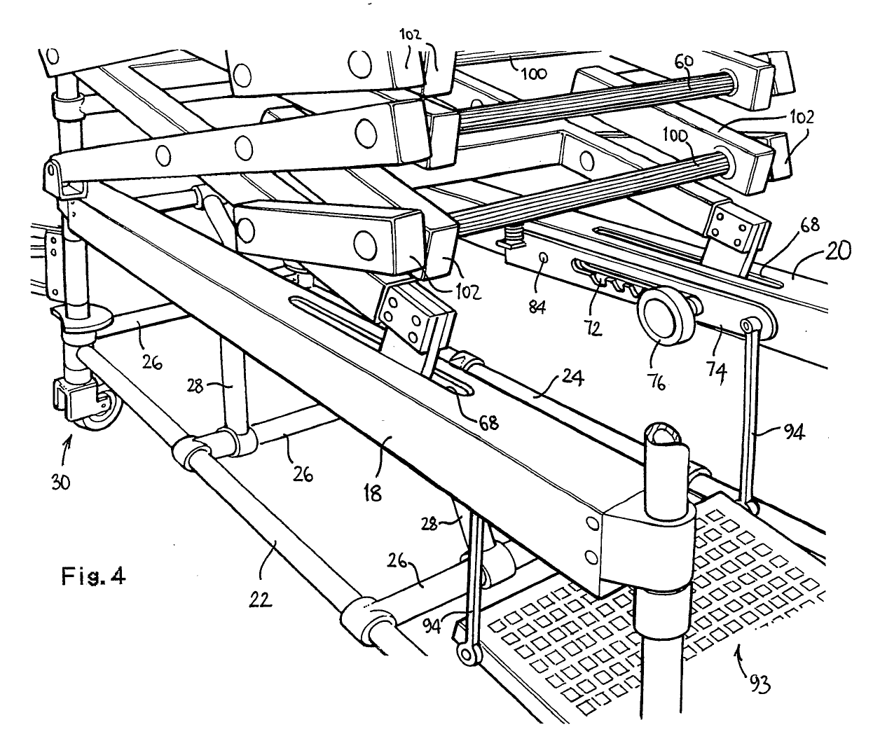

FIG. 4 is an enlarged perspective view of the lower portion of the access tower of FIG. 1, shown in the fully retracted condition;

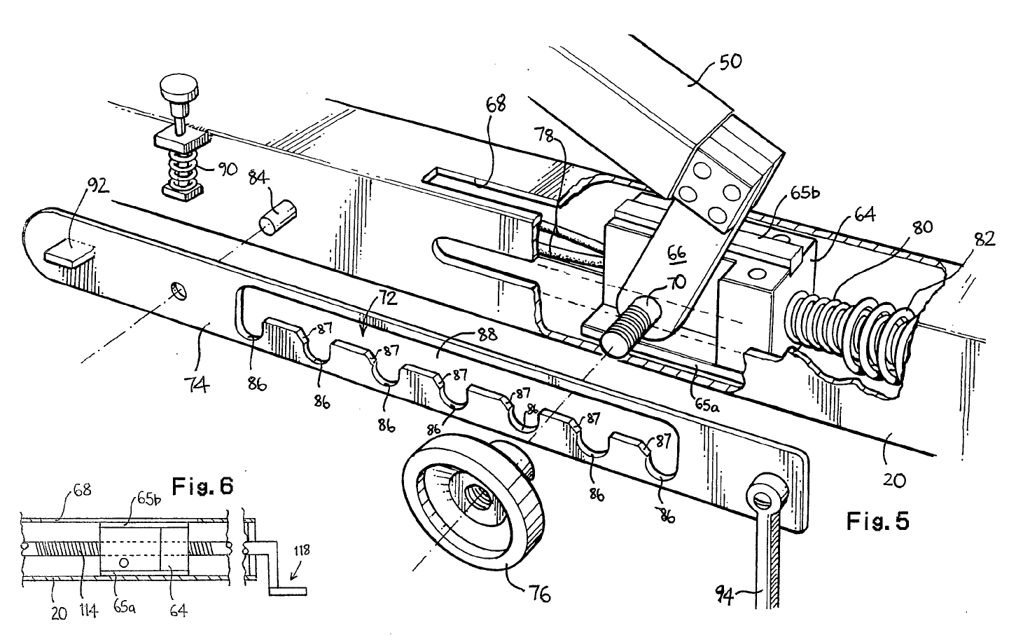

FIG. 5 is an enlarged exploded perspective view, partly cut away, of a lower portion of the access tower of FIG. 1, shown in a partially extended condition;

FIG. 6 is a cross-section through a modification to the access tower of FIG. 1.

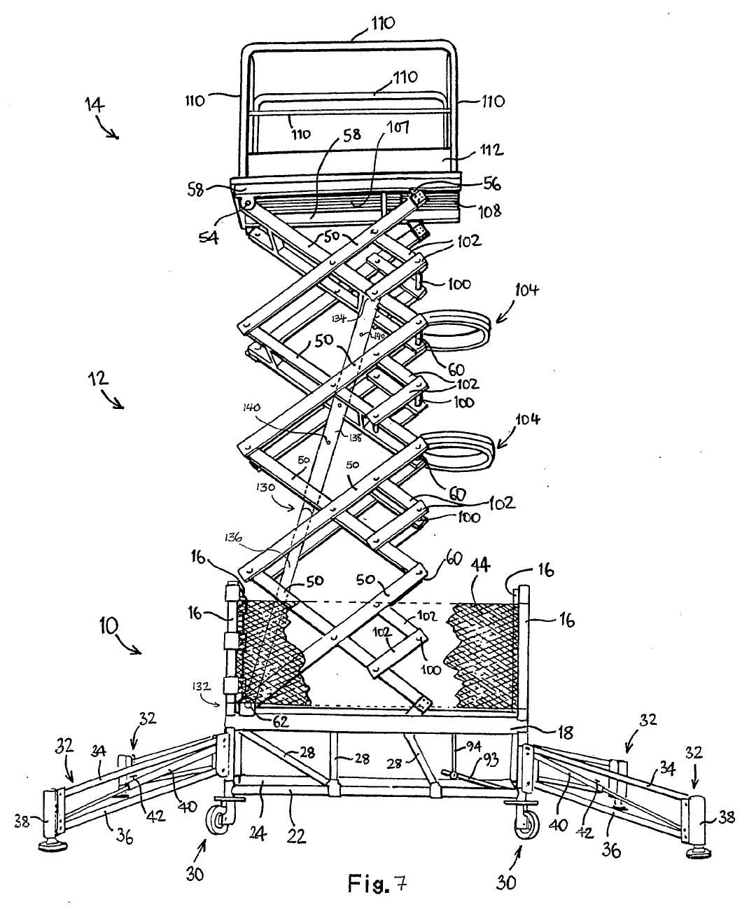

FIG. 7 is a perspective view of another embodiment of an access tower in accordance with the present invention, shown in a fully extended or deployed condition;

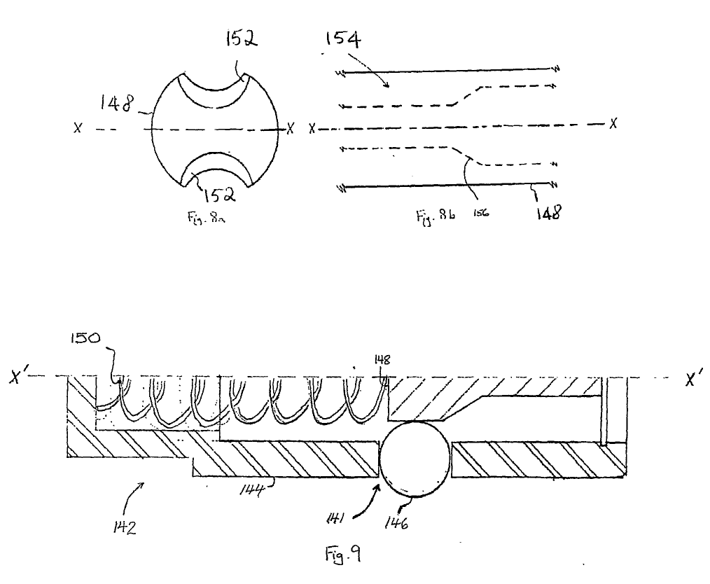

FIG. 8a is a cross sectional view of a portion of the access tower of FIG. 7;

FIG. 8b is a side elevation of the portion of the access tower of FIG. 8a, part of which is shown in phantom; and

FIG. 9 is a partial sectional view of a portion of the access tower of FIG. 7, wherein the line X′-X′ is a line of symmetry.

With reference to the Figures, an access tower comprises a movable wheeled base 10 to which is mounted one end of a scissor lift mechanism 12, the other end of which supports a working platform 14. As shown in FIGS. 1 and 2, the scissor lift 12 can be actuated to displace the working platform 14 between a fully retracted or stowed condition (FIG. 2) and a fully extended or deployed condition (FIG. 1).

The base 10 comprises four vertical corner posts 16. Each of two elongate parallel hollow lateral main beams 18, 20 extends horizontally between a respective pair of the corner posts 16 as do each of two elongate parallel lower subsidiary beams 22, 24, each of which is located beneath, and parallel to, a respective one of the two main beams 18, 20. A plurality of parallel cross-beams 26 extend horizontally between the lower beams 22, 24 and other reinforcing beams 28 interconnect various components of the base.

The base of each corner post 16 is also provided with a brakeable castor 30 and a support leg 32 which can be adjusted between a supporting ground-engaging position (FIG. 1) and a retracted, stowed position (FIG. 2). The rotational position of each support leg with respect to its corner post can be fixed by means of a lock pin (not shown). Each supporting leg comprises parallel upper and lower struts 34, 36 which are pivotally mounted both to the associated corner post 16 and to a ground-engaging foot 38. A telescopic strut 40 extends between the corner post adjacent the inner end of the upper strut and the foot 38 adjacent the outer end of the lower strut and can be clamped at a desired length by means of a screw-threaded clamp 42.

It will also be observed that translucent plastic mesh screens 44, 46 extend between the corner posts 16 along each side of the base 10, primarily to prevent limbs or other objects from becoming trapped in the scissor lift mechanism 12.

The scissor lift mechanism 12 comprises two lazy tong mechanisms 12a, 12b, arranged side-by-side and each comprising four pairs of elongate crossed bars 50, the bars of each pair being pivoted to each other at their centre point and the upper end of each bar 50 being pivotally connected to the lower end of the vertically adjacent bar 50 of the pair of bars immediately above. For the uppermost pair of bars 50, one bar of which is pivotally connected to a fixed pivot 54 on the undersurface of the working platform 14 and the other bar of which is pivotally connected to a block 56 which slides in, and projects from a slot in, a hollow lateral beam 58 forming part of the working platform 14. The two lazy tongs mechanisms 12a, 12b are interconnected by a plurality of bars 60 which extend between the pivotal connections at the ends of the bars 50, which improves the lateral stability of the construction.

For each lazy tongs mechanism 12a, 12b the lower end of one of the lowermost pair of elongate crossed bars 50 is pivotally connected to a fixed pivot 62 located on a respective one of the two lateral main beams 18, 20. The lower end of the other of the lowermost pair of crossed bars 50 is pivotally connected to a block 64 which slides within a respective one of the two main beams 18, 20. The block 64 is provided with a lower planar nylon runner 65a over the whole of its undersurface and an upper elongate nylon runner 65b set into a longitudinally-extending elongate recess in its uppermost face.

As best seen in FIGS. 4 and 5, the block 64 is generally rectangular in cross-section and is dimensioned to fit snugly within the beam 18, 20. A lug 66 fixedly attached to the lower end of the lowermost bar 50 of the lazy tongs mechanism 12a, 12b passes through an elongate slot 68 in the upper wall of the beam 18, 20 and is pivotally connected to a threaded boss 70 which is secured to the block, passes through an elongate slot 70 in a side wall of the beam 18, 20 and through a cut-out 72 in an elongate retaining plate 74 and screw-threadedly receives a hand-actuated securing nut 76.

The block 64 is biassed away from the position in which the access tower is stowed by means of a tension spring in the form of an elastic bungee-type cord 78 connected between one end face of the block and a fixed mounting point (not shown) within the beam 18, 20 and a first metal compression spring 80 engaged with the opposite end face of the block 64. A suitable product is the “PowerSpring” spring manufactured by Lee Spring Limited of Wokingham, England. In addition, a further, short metal compression spring 82 is arranged outside of, and coaxially with, the first metal compression spring 80 and engages with the end face of the sliding block 64 only during the initial portion of travel of the block towards or away from its extreme position in which corresponds to the stowed condition of the access tower.

The properties of the bungee-type cord 78 and first spring 80 are chosen so that the forces which may apply to the blocks 64 are sufficient to approximately balance the forces in the opposite direction from the weight of the scissor lift mechanism 12 and the working platform 14 so that, as will be explained, only a small manual effort will be required to raise or lower the lifting platform 14.

As mentioned previously, the threaded boss 70 on which the lazy tongs mechanism 12a, 12b is pivotally mounted passes through a cut out 72 in a retaining plate 74. Each of the two main beams 18. 20 is provided with a retaining plate 74, each of which is pivotally mounted towards one end on a pivot pin 84 projecting from the inner face of the main beam 18, 20. The cut-out comprises a series of notches 86 which are interconnected by a common longitudinally extending channel 88. The uppermost portion of each notch 86 (except the distal notch) on the side towards the pivot pin 84 is formed into an inclined shoulder 87 to allow the threaded boss 70 to move easily from one notch 86 to the next as the access tower is erected, as will be explained.

Each retaining plate 74 is biassed towards a direction in which the threaded boss 70 engages in one of the notches 86, by means of a compression spring 90 mounted on the main beam 18, 20 on the opposite side of the pivot from the cut-out 72 and engaging with a lug 92 secured to the retaining plate 74. The retaining plates 74 are movable against the restoring forces of the two springs 90 by means of a pivotally-mounted foot-actuated treadle 93, which is pivotally connected to the lower end of each of two vertically extending connecting rods 94, one upper end of each of the connecting rods being pivotally connected to the end of a respective one of the retaining plates 74.

The arrangement of the retaining plates 74, the bosses 70 and the treadle 93 is such that, as the blocks 64 are displaced along the side beams 18, 20 in the direction corresponding to erection of the access tower, each of the bosses 70 slides along the longitudinally extending channel 88 in its retaining plate by pivoting the plate downwardly against the restoring force of the spring 90 to allow the bosses 70 to enter the longitudinally extending channel. The bosses 70 can be retained in a desired position by tightening the hand-actuated nuts 76. This would normally be done when the bosses 70 are each received fully in one of the notches 86.

At the opposite end of the scissor lift mechanism, the blocks 56 are slidable along the lateral beams 58 as described previously. However, in the embodiment described there are no spring members directly engaging the blocks 56 although the blocks 56 can be clamped in a desired position by means of hand-actuated securing nuts 96 which are screw-threadedly received on a threaded boss 98 projecting through a slot in the inner side wall of each of the lateral beams 58.

One side of the scissor lift mechanism 12 also carries a series of rungs 100 which are each pivotally mounted at one end of two pairs of short supporting beams 102, the other end of the beams 102 of each pair being pivotally connected to adjacent upper and lower crossed bars 50 of one of the lazy tong mechanisms 12a, 12b at a point one quarter the length from the upper end of the upper crossed bar 50 and at a point one quarter the length from the lower end of the lower crossed bar 50. In this way, the rungs rise and fall with the scissor lift mechanism 12 and are positioned mid-way between the vertically adjacent bars 60 which extend between the pivotal connections at the ends of the bars 50.

The same side of the scissor lift mechanism 12 also carries two collapsible guard rails 104, secured to the two uppermost bars 60. The guard rails 104 comprise two complementarily profiled curved lengths 106 of plastic which slide one inside the other and one end of each of which is secured to a respective one end of the bar 60. The guard rails 104 can be extended to the position shown in FIG. 1 by sliding apart the two lengths 106 or can be collapsed by sliding one length inside the other.

The working platform 14 comprises a generally planar metal floor 107 secured to the lateral beams 58. The end portion of the floor 107 immediately above the rungs 100 and guard rails 104 is formed into a pivotally-mounted access door 108. The floor 107 is surrounded by a safety cage formed by guard rails 110 and shallow side walls 112 extend upwardly form the periphery of the floor 107.

The access tower is stored in the stowed condition illustrated in FIG. 2, namely with the scissor lift mechanism 12 and the support legs 32 in the retracted condition. The hand-actuated securing nuts 76 and 96 are also tightened to lock the tower in the stowed condition. The access tower can then be wheeled to the desired location when desired and the castors 30 locked in position.

When it is desired to use the access tower, it can be transported to the appropriate location at which the castors 30 are braked and the support legs 32 are deployed in to the position shown in FIG. 1 with the feet 38 engaging the ground. The telescopic struts 40 are then clamped in position by means of the clamps 42.

The next stage is to slacken off the hand-actuated securing nuts 76 from the main side beams 18, 20 and the hand-actuated securing nuts 96 from the lateral beams 58 of the working platform and to extend the guard rails 104 into the operative position illustrated in the Figures. The working platform 14 can then be raised by pulling upwardly on either the rungs 100 or the bars 60 extending between the pivotal connections at the ends of the bars 50. The forces applied to the block by the tension spring (bungee-type cord) 78 and the compression spring 80 urge the blocks 64 in a direction which causes expansion of the scissor lift mechanism. In addition, for the first part of the motion of the block 64 away from the stowed position the additional compression spring 82 also assists in raising the working platform 14. As explained previously, the forces applied by the tension springs 78 and the compression spring 80 are intended to approximately balance the force applied to the blocks 64 from the working platform 14 and the lazy tongs framework 12 in the opposite direction. As a result, the working platform 14 can be raised into the desired position with very little manual effort.

As explained previously, as the blocks 64 slide along their respective main beams 18, 20, the projecting bosses 70 successively engage in the notches 86 in the retaining plate 74. Engagement of the bosses 70 in the notches 86 prevents downward movement of the working platform 14 and scissor lift mechanism 12 and thus guards against inadvertent collapse of the scissor lift mechanism. However, the inclined shoulder 87 on one side of each of the notches 86 allows further longitudinal movement of the blocks 64 in the direction corresponding to extension of the scissor lift mechanism 12 by pivoting the retaining plate 64 against the restoring force of the springs 90, until the bosses 70 engage with the next notch 86.

When the working platform has been raised to the desired height, the hand-actuated nuts 76 are tightened in order to lock the blocks 64 in position. This would normally be done when the bosses 70 were engaged with one of the notches 86, for added safety, in which case the working platform could be raised to one of a plurality of predetermined heights.

As explained previously, as the scissor lift mechanism 12 expands, the rungs 100 move with the mechanism to lie midway between vertically adjacent horizontal bars 60 extending between pivotally-connected ends of the main bars 50 of the scissor lift mechanism. In this way, a ladderway is formed by the bars 60 and rungs 100 located between vertically adjacent bars 60, to allow a person to climb up one side of the scissor lift mechanism 12 towards the working platform 14.

As the person climbing the ladder way approaches the undersurface of the working platform 14, the securing nuts 96 are tightened against the lateral beams 58, to further secure the platform in place and to provide additional rigidity to the construction. The access door 108 can then be pivoted upwardly to gain access to the working platform 14 and once the person is located within the working platform, the access door 108 can be pivoted shut.

When it is desired to collapse the access tower, the reverse sequence of events is adapted.

In another embodiment, the tower is provided with support means for providing stability to the tower when in the extended position or deployed condition. The improved stability is provided for by connecting each of two telescopically extendible legs 130 (only one of which is shown in FIG. 7 for illustrative purposes) between a respective pair of spaced apart mounting points 132, 134 on the scissor mechanism 12, one point 132 at the base of the scissor 12 and the other 134 a little way down from the top end. The telescopic legs 130 are pivotally mounted at each end 132, 134 to take account of the movement of the scissor 12.

Each telescopic leg 130 consists of two cylindrical members 136, 138 which slide one inside the other. The extendible legs 130 can be extended to the position shown in FIG. 7 by sliding apart the two members 136, 138 or can be collapsed by sliding one member 136, 138 inside the other.

The outer (upper) part, cylindrical member 138, of each telescopic leg is provided with a plurality of spaced-apart holes 140 for receipt of locking balls 144 in order to lock the tower in one of a predetermined number of extended positions. The locking mechanism 142 is controlled by the same treadle 93 which controls the retaining plates 74. The positioning of the holes 140 in the telescopic legs 130 corresponds to the spacing of the notches 86 in the retaining plate 74 so that the telescopic legs 130 are in a position to be locked whenever the lug 70 is engaged with one of the notches 86.

The locking mechanism 142 for each telescopic leg 130 consists of a housing 144, two locking balls 146 capable of being urged into and received by a pair of holes 141 in the housing, a cam 148 and a compression spring 150. The locking mechanism 142 is located at and secured to the upper end of the inner cylindrical member 136. The locking balls 146 are biased into the locking configuration by means of the cam 148 which is slidably mounted within the housing 144.

Each cam 148 has a pair of part spherical channels 152 disposed diametrically opposite one another, each of which is shaped at one end to provide a pocket 154 to accommodate a locking ball 146. At the other end of the channel is an inclined face 156 for urging the locking ball 146 into the locking configuration.

Each cam 148 is biased by a compression spring 150 such that each locking ball 146 is urged into the locking configuration. Attached to the cam is a cable (not illustrated) which passes through compression spring 150. In use, the holes 141 can be aligned with holes 140 in the outer cylindrical member 138. Whilst the diameter of holes 141 corresponds to the diameter of the locking balls 146, the diameter of holes 140 is slightly smaller than the locking balls 146 such that the balls 146 be received and retained by holes 140, and to prevent the balls 146 from passing through holes 140.

To disengage the locking balls from the locking configuration enabling the telescopic legs 130 to be collapsed, the same treadle 93 which controls the retaining plates 74 is actuated, as described hereinabove, and cam 148 is downwardly displaced against the action of compression spring 150 by the cable which is operatively connected to the treadle 93. Thus, locking balls 146 are no longer urged into the locking configuration by the inclined face 156 of cam 148, but are received in the pockets 152 permitting cylindrical members 136, 138 to slide one inside the other. The working platform 14 can be raised as described hereinabove, whilst disengaging the locking mechanism 142. Once the working platform 14 has been raised into the desired position, the cable can be released permitting the locking balls 146 to revert to their locking configuration.

The invention is not restricted to the details of the foregoing embodiment. In particular, it is envisaged that the guard rails 104 around the working platform could be arranged to be collapsible to reduce the size of the access tower when in the stowed position.

Moreover, the elastic bungee-type cord spring 78 could be replaced, if desired, with a different type of tension spring, for example a conventional coiled metal tension spring.

Furthermore, although in the previous embodiment the force applied to the lower end of the scissor lift means is in the form of a biassing means, other means, preferably manually powered, for applying force to the lower end of the scissor lift means may be used alternatively or in addition. For example, as illustrated schematically in FIG. 6, the means for applying a force may comprise two screw-threaded bars 114, a respective one extending longitudinally through, and being rotatably mounted in, each of the main beams 18, 20 and being screw-threadedly engaged with a respective one of the blocks 64, whereby rotation of the screw-threaded bars (e.g. by means of manually-operated handles 118 connected to one end of the bars) causes displacement of the blocks 64 along the beams 18, 20 and thereby extension and retraction of the scissor lift means 12.

1. An access tower comprising a base, a scissor lift means having a lower end mounted on the base, a working platform mounted at an upper end of the scissor lift means and means for applying a force to the lower end of the scissor lift means to urge the scissor lift means into an extended condition.

2. An access tower as claimed in claim 2 wherein the means for applying a force comprises biasing means acting on the lower end of the scissor lift means which urge the scissor lift means into the extended condition.

3. An access tower as claimed in claim 2 wherein the biasing means acts only on the lower end of the scissor lift means.

4. An access tower as claimed in claim 3 wherein the biasing means comprises spring means.

5. An access tower as claimed in claim 4 wherein the spring means comprises a spring selected from the group consisting of a tension spring means and a compression spring means.

6. An access tower as claimed in claim 4 wherein the spring means acts on a mounting which is movably mounted on the base.

7. An access tower as claimed in claim 6 wherein the mounting comprises a block which is slidably disposed with respect to the base.

8. An access tower as claimed in claim 7 wherein the block is slidably disposed in a hollow frame member forming part of the base.

9. An access tower as claimed in claim 2 wherein the biasing means applies a force which compensates for at least 75% of an effort required to raise the access tower to an erected condition.

10. An access tower as claimed in claim 9 wherein the biasing means applies a force which compensates for substantially 100% of the effort required to raise the access tower to an erected condition.

11. An access tower as claimed in claim 1 further comprising support means for providing structural support to the scissor lift means in the extended condition.

12. An access tower as claimed in claim 11 wherein the support means comprises at least one telescopically extendible leg, extendible between a stowed condition and at least one predetermined extended condition.

13. An access tower as claimed in claim 12 wherein at least one telescopically extendible leg has a plurality of predetermined extended configurations so as to accommodate varying heights of the working platform relative to the base.

14. An access tower as claimed in claim 12 wherein the support means comprises a pair of telescopically extendible legs.

15. An access tower as claimed in claim 11 wherein the support means is mountable on the access tower.

16. An access tower as claimed in claim 15 wherein the support means is pivotally mounted on the access tower.

17. An access tower comprising a base, scissor lift means having a lower end mounted on the base and a working platform mounted at an upper end of the scissor lift means, the scissor lift means comprising two spaced-apart lazy tongs assemblies and further comprising a plurality of laterally extending bars extending between the two lazy tongs assemblies.

18. An access tower as claimed in claim 17 wherein the laterally extending bars extend between load-supporting members on each of the two lazy tongs assemblies.

19. An access tower as claimed in claim 18 wherein the laterally extending bars form a pivot for each of the two lazy tongs assemblies.

20. An access tower as claimed in claim 17 wherein the scissor lift means comprises a laterally-extending bar mounted on a linkage connected to one or both of the lazy tongs assemblies which causes the bar to rise and fall with the scissor lift means.

21. An access tower as claimed in claim 20 wherein the linkage may comprise two parallelogram linkages located one on each of the lazy tongs assemblies.
